(19) United States
(12) Patent Application Publication
(10) Pub. No.: US 2021/0287117 A1
(43) Pub. Date: Sep. 16, 2021

(54) BLOCKCHAIN IMPLEMENTED DISTRIBUTED PROCESSING OF ARTIFICIAL INTELLIGENCE FOR DATA ANALYSIS

(71) Applicant: Ark.One Health, Inc., San Ramon, CA (US)

(72) Inventors: Shahram Shawn Dastmalchi, San Ramon, CA (US); Rodd Dastmalchi, San Ramon, CA (US); Anthony Michael LaRocca, Middleburg, FL (US)

(21) Appl. No.: 17/196,995

(22) Filed: Mar. 9, 2021

Related U.S. Application Data
(60) Provisional application No. 62/988,366, filed on Mar. 11, 2020.

(51) Int. Cl. G06N 5/04; G06F 16/27; G06N 20/00; G06Q 10/06

(52) U.S. Cl. CPC G06N 5/04; G06Q 10/067; G06N 20/00; G06F 16/27

(57) ABSTRACT

The technology disclosed relates to real-time payment/incentive system, and performance improvement, forecasting, and benchmarking. The technology disclosed also relates to distributed processing, quality checking, and learning. The disclosed systems and methods rely upon a trusted distributed blockchain database for feature and model storage to effectuate processing of the real-time payments.

### CROSS REFERENCE TO RELATED APPLICATION

This application claims priority to U.S. Provisional Patent Application No. 62/988,366, entitled “Artificial Intelligence-Based Guided Medical Care Pathway” filed Mar. 11, 2020 (Attorney Docket No. ARK1 1002-1), which is incorporated by reference herein for all purposes.

### BACKGROUND

The present invention relates to systems and methods for artificial intelligence type computers and digital data processing systems and corresponding data processing methods and products for emulation of intelligence (e.g., knowledge based systems, reasoning systems, and knowledge acquisition systems); and including systems for reasoning with uncertainty (e.g., fuzzy logic systems), adaptive systems, machine learning systems, and artificial neural networks. In particular, the technology disclosed relates to using deep neural networks, such as deep convolutional neural networks for analyzing data, in a distributed manner reliant upon blockchain for workflow fidelity. In some implementations, the technology disclosed relates to real-time payment/incentive system, and performance improvement, forecasting, and benchmarking for a wide variety of industries and fields of use. The technology disclosed also relates to distributed processing, quality checking, and learning.

In many industries and workflows there is an inherent inability to establish best practices for a service or delivery due to mistrust between constituent parts of the workflow, and due to the fact that controlled studies are often conducted under non-uniform conditions. This may be particularly true for the medical field, where the impact of the well-established/studied best practices is not fully known for a given patient population or a subject setting because the best practices studies are controlled studies that are often conducted under different setting and patient population parameters.

Moreover, incentive payments rewarding compliance with the best practices are delayed (e.g., by as much as 18 months after the best practice execution) due to the inability to establish meaningful best practices, and also due to delays in payment processing within particular industries (again, this may be particularly pronounced within the medical setting). Further, many of the best practices are yet to be discovered and learned because the rate of research establishing best practices is very slow and as a result many of the best practices are not timely captured and recorded. Additionally, control studies are a time-consuming and expensive ventures.

Many services rendered are fee for service (FFS) and therefore encourage volume, not quality. Again, within the United States, medical care falls within such a category; however, many other industries and services are similarly situated. In order to improve quality of the service and outcomes, parties to the workflow may rely upon fixed fee, and value-based payments. For example, within the medical setting, insurance companies and Center for Medicare and Medicaid Services (CMS) have been experimenting with various types of value-based payments (VBP). These VBP contracts often require the provider organization to report back on a set of quality metrics. These metrics measure things like outcomes or processes (collectively called Quality Measures) that have shown in studies to impact cost and quality of care.

The retrospective nature of the quality measure reporting (often 12 to 18 months delayed) and not knowing the actual impact of each measure, does not encourage adherence, despite monetary incentives from payers. Another issue is that providers deal with various payers, each with their own set of quality measure obligations, making it difficult to look up and consider the various obligations when making decisions.

As an example, a primary care doctor who is seeing 30 patients per day would have to look up 30+ quality measures for each payer (with often unique aspects) and consider which one is appropriate to be included in each care plan. Given the vast and confusing set of payer obligations, the doctors in many cases do not customize their care in order to adhere to the quality measures even though there are monetary incentives to do so. The same can be said for a wide variety of service based industries where the service recipient is disconnected from the payer (most frequently in insurance paid situations, but not limited to medical care).

The long-standing mistrust between payers and providers, combined with data protection regulations has hindered data sharing between these organizations and the possibility of harmonizing quality measures. Additionally, given the diversity in service recipient attributes (e.g., medical history, socio-economic factors, etc.) and diversity in service delivery settings (e.g., single-specialty practice, multi-specialty practice, hospital, nursing home, etc.), the service provider tends to tailor his/her interventions more towards the needs of each recipient and the capabilities of the settings as opposed to ensuring quality measure adherence. The service provider knows that quality measures are born out of controlled studies and do not take into account many of the important considerations, so it is a fair point for them to say, “my recipients are different.”

It is therefore apparent that an urgent need exists for a control mechanism for a using blockchain as a trustless system of sharing machine-learned knowledge and performance benchmarks. Additionally a machine learning framework estimates of the impact of provider actions on future outcomes, and their potential cost savings.

### SUMMARY

The technology disclosed relates to artificial intelligence-based systems and method of best practices compliance during a service related pathway. In some embodiments, training data is accessed. The training data may contain recipient attributes-to-quality measures mappings for a plurality of payers. These mapping may be stored on an immutable and fully transparent blockchain network.

One or more artificial intelligence-based models are trained using the training data, including generating coefficients of the artificial intelligence-based models that: map the patient attributes to the quality measures according to the recipient attributes-to-quality measures, and predict a value of steps executable by service providers in the path by determining whether a given step contributes positively or negatively towards compliance with the mapped quality measures and therefore causes cost decreases or increases in the pathway and brings about desirable or undesirable future outcomes. The trained artificial intelligence-based models are then stored on the blockchain network.

Incoming recipient attributes are then received. The trained models are then accessed, and applied to the incoming recipient attributes. This predicts value of steps executed by the service providers in the pathway by determining whether the steps performed contributes positively or negatively towards the compliance with the mapped quality measures, as before. This then triggers, in real time, payment incentives for the service providers based on the decreases in the cost. These incentives are then given to the providers. The systems and methods disclosed may leverage smart contracts to customize the real-time payment incentives for the service providers on a payer-by-payer basis.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which:

FIG. 1 is a block diagram that shows various aspects of a blockchain implementation of the technology disclosed, in accordance with some embodiments;

FIG. 2 shows one implementation of blockchain-based mapping between data features and quality measures and blockchain-implemented models and data processors, blockchain-implemented benchmarks of the models and the data processors, and transactions generated on the blockchain network by the models and the data processors, in accordance with some embodiments;

FIG. 3 illustrates one implementation of the technology disclosed in which results and definitions for the models, data features, and benchmarks previously stored on the blockchain network or another form of storage are used to process incoming transaction requests, in accordance with some embodiments;

FIG. 4 shows one implementation of selecting data processors in a feature-dependent manner, in accordance with some embodiments;

FIG. 5 shows one implementation of unit testing in which a quality checker accesses publicly available benchmark information about models and data processors, in accordance with some embodiments;

FIG. 6 demonstrates a real-world streaming analytics example in which an event called First Administered Furosemide captures the timing, dosage, and prescriber information about first administration of Furosemide medication since admission of a heart failure patient to a hospital, in accordance with some embodiments; and

FIG. 7 is a computer system that can be used to implement the technology disclosed, in accordance with some embodiments.

### DETAILED DESCRIPTION

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown, but is to be accorded the widest scope consistent with the principles and features disclosed herein.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The technology disclosed combines machine learning and blockchain technologies to resolve the mistrust between payers and providers and in order to 1) quantify the impact of quality measures on outcomes (quality and cost) on a global stage and harmonize the care of similar service recipients irrespective of their insurance plan (or other third party payer), 2) uncover and quickly test new and more granular quality measures on a global scale in order to nuance the service in the way providers are comfortable with, and 3) offer real-time incentive payments concurrent with the provider actions that positively impact these quality measures.

The first two benefits are effectuated by using blockchain as a trustless system of sharing machine-learned knowledge and performance benchmarks. The third benefit is effectuated by our machine learning framework estimates of the impact of provider actions on future outcomes, and their potential cost savings. Therefore, a portion of the estimated savings (/loss) can be shared with each individual provider (e.g., in the medical setting this includes, for example, physician, nurse, care navigator, social worker, and others involved in the care of a given patient) at the time of their positively (/negative) impacting actions. This sharing of provider performance, service knowledge, and benchmarking enables real time incentive payments to be harmonized across all payer networks. Of course, by way of smart contracts, any one payer can customize payment rates for each quality measure and therefore maintain their own unique business model.

In one implementation, the technology disclosed uses artificial intelligence to discover undiscovered/unpublished best practices at a much higher rate than the typical publication route.

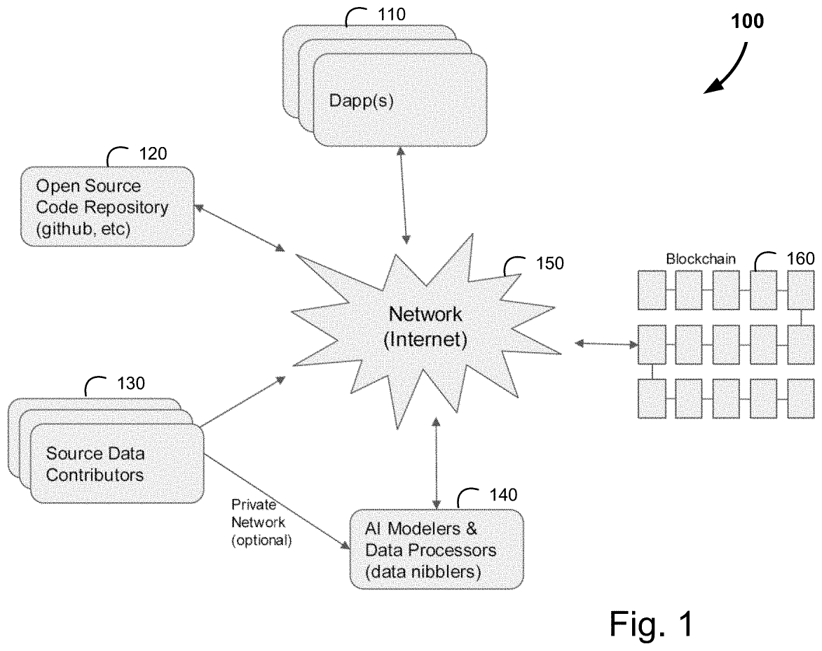

FIG. 1 is a block diagram that shows various aspects of a blockchain implementation of the technology disclosed, shown generally at 100. The block diagram comprises applications (Dapp(s)) 110 that are configured to execute the logic prescribed in smart contracts and manipulate data stored on the blockchain network 160. The open code repository 120 has source code that serves as data processors for processing the data stored on the blockchain network. The logic for the processing by the data processors is provided by the artificial intelligence modelers and data processors 140. Data on the blockchain network is sourced by source data contributors 130 such as enterprise applications (e.g., medical care databases and applications, for example). A wide area network 150, such as the internet, can be leveraged to couple each of these constituent parts.

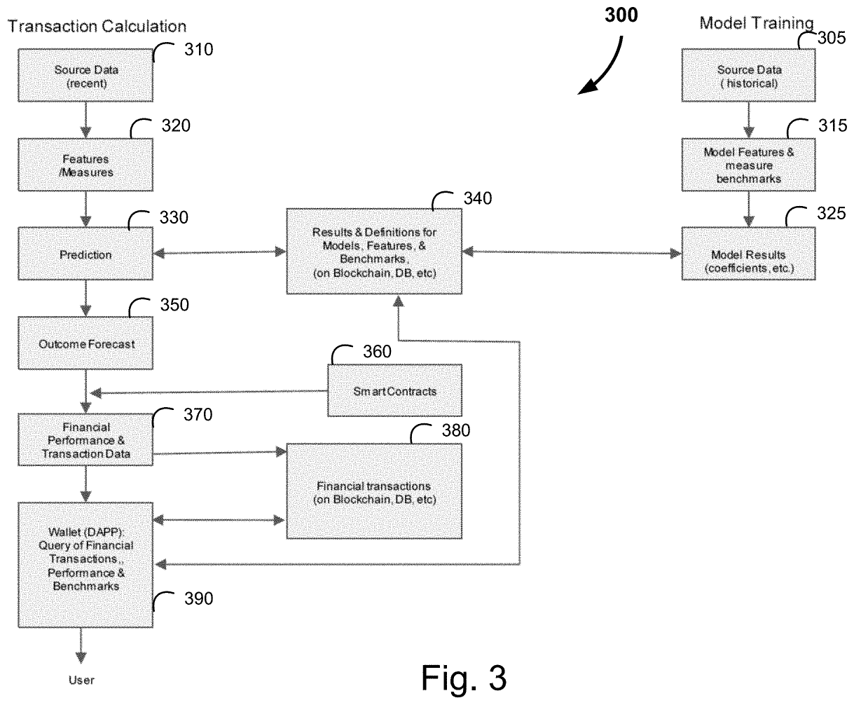

FIG. 3 illustrates one implementation of the technology disclosed in which results and definitions for the models, data features, and benchmarks previously stored on the blockchain network or another form of storage are used to process incoming transaction requests, shown generally at 300.

The quality measures and domain knowledge are shared across providers (e.g., medical care providers) and payers (e.g., insurance companies) on the immutable, shared, fully transparent blockchain network by hosing the model coefficients and measure statistics on the immutable, shared, and fully transparent blockchain network. Blockchain enables shared governance across all the participants, and therefore does not rely on any given participant to manage and manipulate/abuse the data. That is, data management and use is not governed by a single participant.

In some embodiments, the AI models are trained, whereby historical source data is collected (at 305). This data is used to extract out benchmark model features and measures (at 315). These are fed into the deep neural network to generate model results (at 325). This data is all contained within a blockchain database (at 340).

The transaction calculations start with source data (at 310), which are used to extract features (at 320). These are fed into the model that leverages the results definitions for the models and features and definitions which have all been stores in the blockchain database (previously at 340), to generate predictions for the transaction (at 330). The outcome forecasts are based upon these predictions (at 350). Smart contract information (at 360) is used in conjunction with these forecasted outcomes to calculate the financial performance for the given transaction (at 370). Financial transactions may be performed, and recorded on the blockchain database (at 380), and the wallet applications, and other transaction data may be made available to the user (at 390).

The key advantages of a big data system (including machine learning and AI) is that it can process a large variety of input data at scale and produce thousands or even millions of model features. However, developing and operating Big Data (and machine learning) solutions present many challenges: 1) Model feature engineering is a laborious process and it requires high degree of data science skills and application domain knowledge, making it an expensive endeavor to build such systems. 2) Furthermore, the software code that processes the data are not easily unit testable because their behavior not only depends on formatting and schema but also the populations statics of the input data. The garbage-in-garbage-out paradigm makes it challenging to reliably share source code through open source communities, not knowing if the code has made correct assumptions for a given data set and application needs.

This issue is further exacerbated since many features are constructed using other features as their input data and one can quickly end up with layers of dependency that is nearly impossible to track and test. So, throwing more data scientist at the project does very little to speed up the development. 3) It is challenging to scale up routine operations even when the technology itself can scale. Many issues are discovered downstream of the modeling step; and it becomes an operational nightmare to investigate all upstream data processing steps, spot the root cause and reprocess the data.

For example, consider development and processing of the following model feature: for a congestive heart failure patient admitted to the hospital, is the elapsed time before dosage increase for a given category of diuretic medications within 8 hours, when the patient's urine output reading was below 1.0 liters within 4 hours of initial administration of the same category of medication prescription. This model feature can be used to measure the effectiveness of guideline-driven care is constructed using several other features, each using several data domains pulled from the electronic health record system (EHR) including patient and encounter identification, medication prescription, diagnosis, and quantitative urine measurements. Needless to say, that this is just one of many input features to a model.

Development of such measures requires a) domain knowledge (e.g., groups of medications that have equivalency), b) need to coordinate development and testing of several component features, c) check input and output data for completeness, formatting, schema and statistical tolerance, and d) ensuring that dependency between more complex features on simpler feature does not result in an error when data availability is out of sequence.

The client operators need to a) determine which data modalities are to be requested from the client for a given model or application, b) monitor input and output of each data processing step and when anomalies found, make a determination if any of the steps need to be re-run following a data or code fix, and c) communicate and address input data issues quickly with the source which is often a client originations.

The technology disclosed, in an efficient and scalable manner, monitors and fixes big data issues, including corrupted input data, data processor erroring out, output feature corrupted, data processor having incorrect assumptions for a given modeling framework, and unexpected predictions. The technology disclosed makes use of blockchain to store knowledge of input and output data characteristics, source code for data processors, interdependency between data processors, artificial intelligence and machine learning model coefficients, and prediction accuracy.

The proposed trustless, blockchain-enabled, knowledge system can be used in conjunction with open source repositories to 1) quickly acquire, repurpose and test new data processing or ML technologies, 2) distribute development across large number of teams within an organization or across other independent organizations, 3) rapid selection and testing of new features particularly higher order terms/features by simply reviewing a global data set of features and their impact on various models 4) quickly test modeling assumptions against a global set of data quality checks and performance benchmarks, and 5) operationally scale monitoring and reprocessing of data.

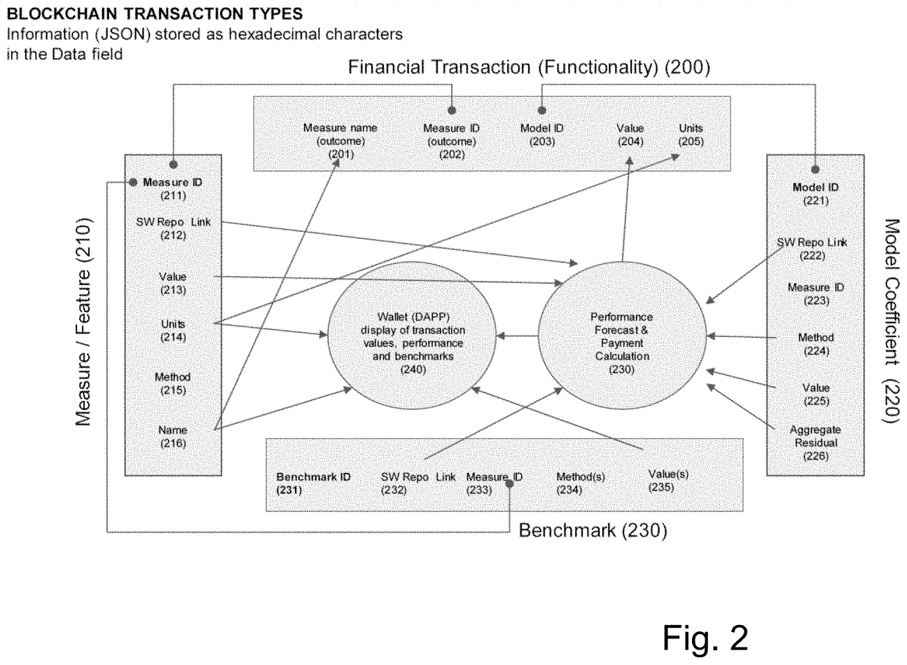

FIG. 2 shows one implementation of blockchain-based mapping between data features and quality measures 210 and blockchain-implemented models and data processors 220, blockchain-implemented benchmarks 230 of the models and the data processors 220, and transactions 200 generated on the blockchain network by the models and the data processors 220.

As shown in FIG. 2, the data features and quality measures are identified by measure ID 211 (alternatively feature ID) and further include metadata fields 212, 213, 214, 215, and 216. The metadata fields 212 to 216 are made to corresponding ones of the metadata fields in the blockchain-implemented models and data processors 220, the blockchain-implemented benchmarks 230 of the models and the data processors 220, and the transactions 200 generated on the blockchain network by the models and the data processors 220.

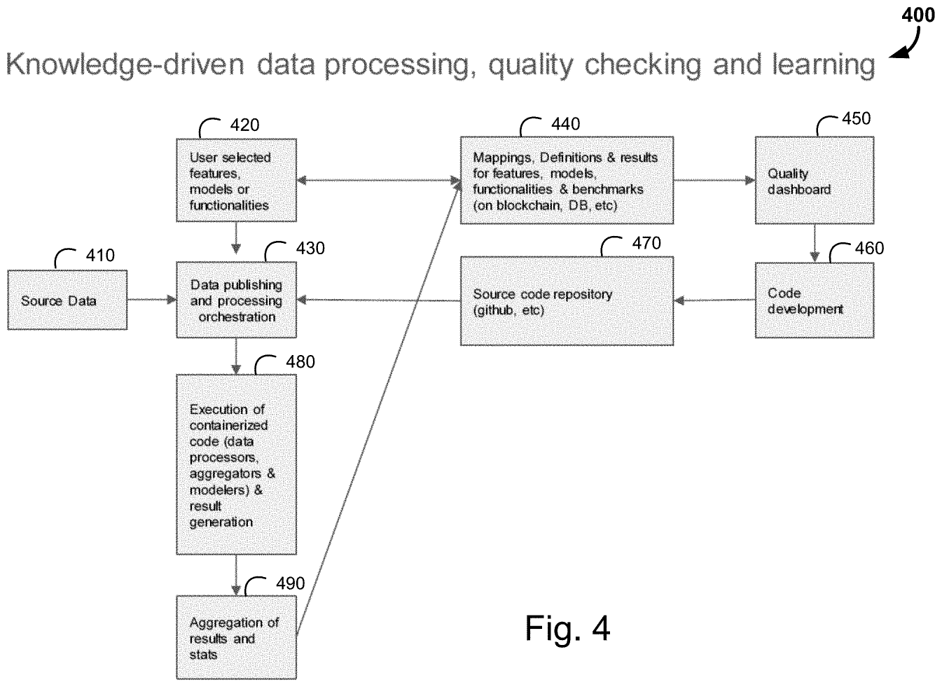

FIG. 4 shows one implementation of selecting data processors in a feature-dependent manner. The mappings, definitions, and results for data features, models, functionalizes, and benchmarks are stored on the blockchain network and/or another form of memory, shown at 440. The mappings are used to select which of the models and the data processors are used to process incoming data features. The data features are selected by the user, at 420. That is, the most suitable data processors (e.g., source code from the source code repository 470) for a subject data 410 feature are selected based on the stored mapping, at 430.

After selection, the data features are executed in a containerized code by the selected data processors, at 480. The results of the processing 490 are then stored back onto the blockchain network 440 and used for future development and optimization of data processors (e.g., code development 460) via a quality dashboard 450, and code deployment on the source code repository 470.

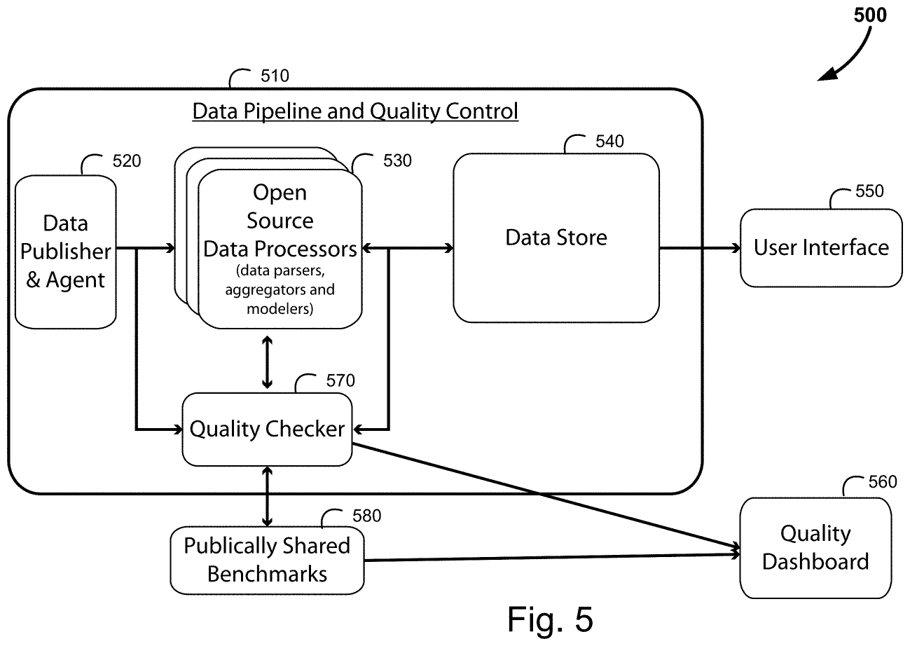

FIG. 5 shows one implementation of unit testing in which a quality checker accesses publicly available benchmark information about models and data processors, shown generally at 500. This data pipeline and quality control system 510, accesses data from a data publisher and agent 520. The quality checker 570 compares real-time processing results from open source data processors 530 and outputs of the data processors with the publicly available benchmark information 580 (e.g., stored on the blockchain and/or another form of storage). These outputs are recorded in a data store 540, which is accessible by a user interface 550. A quality dashboard 560 displays the results of the quality checker and publicly shared benchmarks. The quality checker infers whether the models and data processors are performing at an optimal level or not.

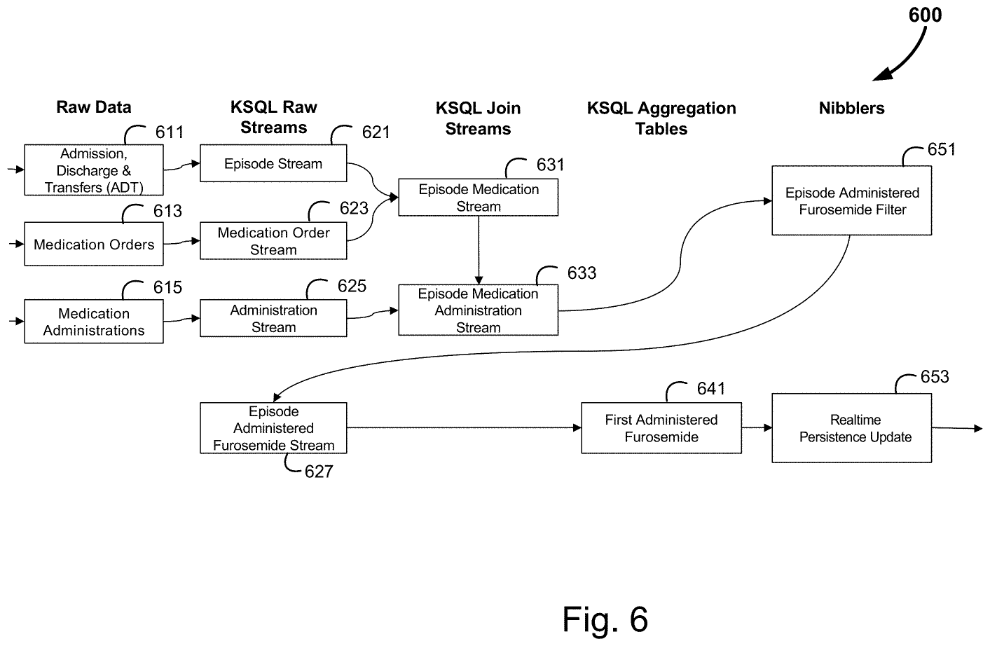

FIG. 6 demonstrates a real-world streaming analytics example within the medical field of use, shown generally at 600. While a medical industry has been referenced throughout this application, it should be understood that the disclosed systems and methods are equally applicable to other service industries and have particular utility in which the payer of the system is independent from the service recipient.

This example is in which an event called First Administered Furosemide captures the timing, dosage, and prescriber information about first administration of Furosemide medication since admission of a heart failure patient to a hospital. The medication event is computed using three sources of raw data (ADT 611, Medication Orders 613, Medication Administration Records 615). ADT data is processed by an episode stream 621. Likewise, the medication order are processed by a medication order stream 623. These are combined in an episode medication stream 631. The medication administration records are processed by an administration stream 625, the results of which are combined with the episode medication stream into an episode medication administration stream 633.

Output of the episode medication administration stream is provided to an episode administered Furosemide filter 651, with the output of this nibbler returned to a raw stream for episode administered Furosemide 627. The output of which is aggregated into a table for episode administered Furosemide 641, which is in turn consumed by a nibbler to generate a real-time persistence update 653.

The input/output of each pipeline step can be monitored for 1) syntactic validity every event and 2) statistical validity after a threshold number of samples have been gathered and compared against publicly available benchmarks (e.g., stored on the blockchain and/or another form of storage). This approach of correlating the results generated by open source software against prior results generated by the same exact software version provides a way to continuously monitor data quality and unit test each pipeline step to ensure functional validity.

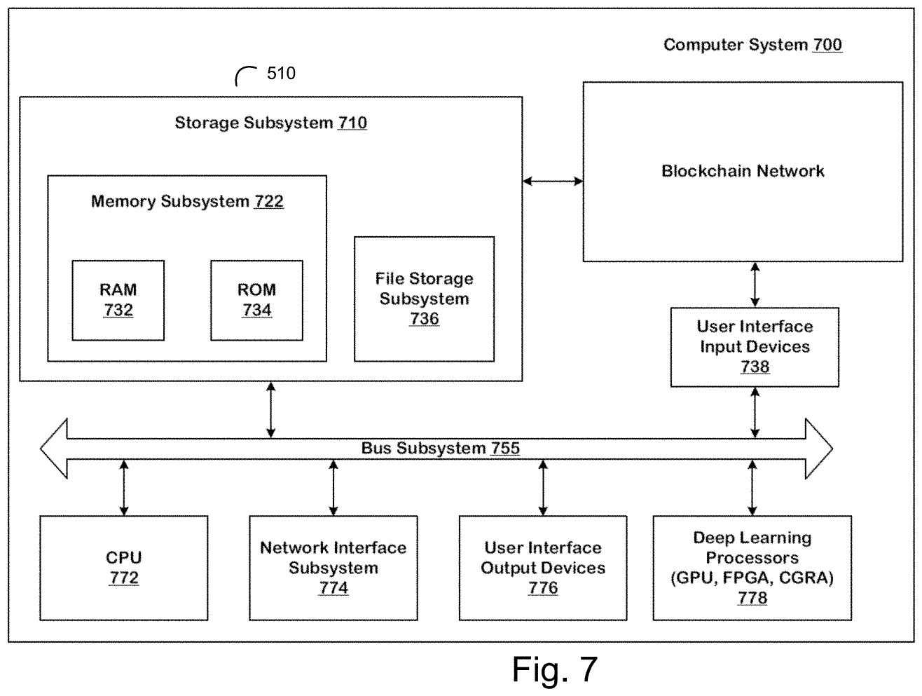

Now that the systems and methods for the control of a blockchain enabled AI processing system for resolving the mistrust between payers and providers have been described, attention shall now be focused upon systems capable of executing the above functions. FIG. 7 is a computer system 700 that can be used to implement the technology disclosed. Computer system 700 includes at least one central processing unit (CPU) 772 that communicates with a number of peripheral devices via bus subsystem 755. These peripheral devices can include a storage subsystem 710 including, for example, memory devices and a file storage subsystem 736, user interface input devices 738, user interface output devices 776, and a network interface subsystem 774. The input and output devices allow user interaction with computer system 700. Network interface subsystem 774 provides an interface to outside networks, including an interface to corresponding interface devices in other computer systems.

In one implementation, the blockchain network is communicably linked to the storage subsystem 710 and the user interface input devices 738.

User interface input devices 738 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 700.

User interface output devices 776 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 700 to the user or to another machine or computer system.

Storage subsystem 710 stores programming and data constructs that provide the functionality of some or all of the modules and methods described herein. These software modules are generally executed by deep learning processors 778.

Deep learning processors 778 can be graphics processing units (GPUs), field-programmable gate arrays (FPGAs), application-specific integrated circuits (ASICs), and/or coarse-grained reconfigurable architectures (CGRAs). Deep learning processors 778 can be hosted by a deep learning cloud platform such as Google Cloud Platform™, Xilinx™, and Cirrascale™. Examples of deep learning processors 778 include Google's Tensor Processing Unit (TPU)™, rackmount solutions like GX4 Rackmount Series™, GX7 Rackmount Series™ NVIDIA DGX-1™, Microsoft' Stratix V FPGA™, Graphcore's Intelligent Processor Unit (IPU)™, Qualcomm's Zeroth Platform™ with Snapdragon Processors™, NVIDIA's Volta™ NVIDIA's DRIVE PX™, NVIDIA's JETSON TX1/TX2 MODULE™, Intel's Nirvana™ Movidius VPU™, Fujitsu DPI™, ARM's DynamiclQ™, IBM TrueNorth™, Lambda GPU Server with Testa V100s™, and others.

Memory subsystem 722 used in the storage subsystem 710 can include a number of memories including a main random access memory (RAM) 732 for storage of instructions and data during program execution and a read only memory (ROM) 734 in which fixed instructions are stored. A file storage subsystem 736 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 736 in the storage subsystem 710, or in other machines accessible by the processor.

Bus subsystem 755 provides a mechanism for letting the various components and subsystems of computer system 700 communicate with each other as intended. Although bus subsystem 755 is shown schematically as a single bus, alternative implementations of the bus subsystem can use multiple busses.

Computer system 700 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 700 depicted in FIG. 7 is intended only as a specific example for purposes of illustrating the preferred implementations of the present invention. Many other configurations of computer system 700 are possible having more or less components than the computer system depicted in FIG. 7.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Many modifications to the above described embodiments are contemplated within the spirit of the present invention. For example, many other Fee-For-Service (FFS) ecosystems inefficiently incentivize volume over quality. In this context, it is also contemplated that “services” is intended to also apply to many permutations of products and/or services. Exemplary applicable FFS ecosystems include business consulting services such as reorganizations, legal services such as complex litigation, infrastructure and/or construction projects such as high-speed rail systems, technology engineering projects such as developing new commercial aircraft or new vehicles, accounting services such as external audits, and financial services such as investment advisory services.

Hence, in order to eliminate or minimize this expensive drawback inherent in FFS ecosystems, embodiments of the present invention can adapt the above described blockchain database to generate reliable predictions for FFS transactions. The outcome forecasts are based upon these predictions, and smart contract information is used in conjunction with these forecasted outcomes to calculate the financial performance for the given transaction, thereby enabling payers to efficiently and equitably contract with providers for these FFS.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computer-implemented method of selecting data processors in a feature-dependent manner, the method including:
storing on a blockchain network, a mapping between data features and (i) models that include logic for processing the data features and (ii) data processors that process the data features by applying the logic of the models to the data features, wherein the mapping is based on:
dependency of a subject data feature on other data features as part of inputs to the data processors for generation of an analytics event as output of a processing pipeline;
input characteristics of the subject data feature and the other data features and output characteristics of the analytics event, including completeness, formatting, schema, and statistical tolerance,
interdependency between the data processors, including functionality of the data processors and position of the data processors in the processing pipeline, and
coefficients and prediction accuracy of the models;
in response to receiving an incoming request for processing a particular data feature, accessing the mapping from the blockchain network and selecting a particular one of the models and a set of the data processors based on the accessed mapping; and
processing the particular data feature and other additional data features that supplement the particular data feature through the selected particular one of the models and the set of the data processors to generate one or more analytics events for the particular data feature.

2. The artificial intelligence-based method of claim 1, wherein the models are artificial-intelligence models.

3. The artificial intelligence-based method of claim 1, wherein the data processors comprise source code.

4. The artificial intelligence-based method of claim 1, wherein the data processors include data queues, data collectors, and data streamers.

5. The artificial intelligence-based method of claim 1, wherein the data processors include data joiners.

6. The artificial intelligence-based method of claim 1, wherein the data processors include data reducers and data aggregators.

7. The artificial intelligence-based method of claim 1, wherein the data features are clinical events, including medication data, diagnosis codes, procedures and lab results, and/or metadata feature, the processing pipeline implements guided medical care pathway, and the analytics event is a guided medical care pathway event.

8. A computer-implemented method of unit testing data processors based on one or more prior benchmarks, the method including:
storing on a blockchain network, benchmark information for a processing pipeline that comprises a plurality of data processors, including data processor-specific benchmarks for each data processor in the plurality of data processors, wherein the benchmarks are generated based on a prior processing performance of the data processors;
in response to receiving an incoming request for processing a particular data feature, processing the particular data feature and other data features that supplement the particular data feature through one or more of the data processors of the processing pipeline and generating one or more outputs for the one or more of the data processors;
monitoring data quality and unit testing the one or more of the data processors to ensure functional validity by comparing, during the processing, the benchmarks against the respective ones of the outputs; and
based on the comparing, triggering an alter when the results of the comparison indicate a decline in quality below a present threshold.

9. The artificial intelligence-based method of claim 8, further comprising based on the comparing, detecting sporadic drifts in patient population characteristics, including viral outbreaks.

10. An artificial intelligence-based method of best practices compliance during a service related pathway, the method including:
accessing training data that includes recipient attributes-to-quality measures mappings for a plurality of payers and storing the mappings on an immutable and fully transparent blockchain network in which each of the payers participates, wherein each of the recipient attributes-to-quality measures mappings is specific to a respective one of the payers;
training artificial intelligence-based models using the training data, including generating coefficients of the artificial intelligence-based models that:
map the recipient attributes to the quality measures according to the recipient attributes-to-quality measures, and
based on the mapping, predict value of one or more steps executable by service providers in the service related path by determining whether a particular one of the steps contributes positively or negatively towards compliance with the mapped quality measures and therefore causes cost decreases or increases in the service related pathway and brings about desirable or undesirable future outcomes of the service related pathway;
storing the trained artificial intelligence-based models on the blockchain network;
in response to receiving incoming recipient attributes, accessing the trained artificial intelligence-based models from the blockchain network and applying the trained artificial intelligence-based models to the incoming recipient attributes, including predicting value of one or more of the steps executable by the service providers in the service related path by determining whether the particular one of the steps contributes positively or negatively towards the compliance with the mapped quality measures and therefore causes the cost decreases or increases in the service related pathway and brings about desirable or undesirable future outcomes of the service related pathway; and
upon execution of the steps by the service providers that contribute positively towards the compliance with the mapped quality measures, triggering, in real-time, payment incentives for the service providers based on the decreases in the cost and delivering the payment incentives to the service providers.

11. The artificial intelligence-based method of claim 10, further comprising using smart contracts to customize the real-time payment incentives for the service providers on a payer-by-payer basis.

12. The artificial intelligence-based method of claim 10, wherein the training data includes benchmarks for the service.

13. The artificial intelligence-based method of claim 10, wherein the training data includes clinical knowledge required for medical care.

14. The artificial intelligence-based method of claim 10, wherein the recipient refers to a patient.

15. A non transitory computer readable memory product, that when executed on a computer system performs the steps of:
accessing training data that includes recipient attributes-to-quality measures mappings for a plurality of payers and storing the mappings on an immutable and fully transparent blockchain network in which each of the payers participates, wherein each of the recipient attributes-to-quality measures mappings is specific to a respective one of the payers;
training artificial intelligence-based models using the training data, including generating coefficients of the artificial intelligence-based models that:
map recipient attributes to the quality measures according to the recipient attributes-to-quality measures, and
based on the mapping, predict value of one or more steps executable by service providers in the service related path by determining whether a particular one of the steps contributes positively or negatively towards compliance with the mapped quality measures and therefore causes cost decreases or increases in the service related pathway and brings about desirable or undesirable future outcomes of the service related pathway;
storing the trained artificial intelligence-based models on the blockchain network;
in response to receiving incoming recipient attributes, accessing the trained artificial intelligence-based models from the blockchain network and applying the trained artificial intelligence-based models to the incoming recipient attributes, including predicting value of one or more of the steps executable by the service providers in the service related path by determining whether the particular one of the steps contributes positively or negatively towards the compliance with the mapped quality measures and therefore causes the cost decreases or increases in the service related pathway and brings about desirable or undesirable future outcomes of the service related pathway; and
upon execution of the steps by the service providers that contribute positively towards the compliance with the mapped quality measures, triggering, in real-time, payment incentives for the service providers based on the decreases in the cost and delivering the payment incentives to the service providers.

16. The computer memory product of claim 15 that when executed by a computer system further performs the steps of using smart contracts to customize the real-time payment incentives for the service providers on a payer-by-payer basis.

17. The computer memory product of claim 15, wherein the training data includes benchmarks for the service.

18. The computer memory product of claim 15, wherein the training data includes clinical knowledge required for medical care.

19. The computer memory product of claim 15, wherein the recipient refers to a patient.
